(19) United States
(12) Patent Application Publication
(10) Pub. No.: US 2012/0102714 A1
(43) Pub. Date: May 3, 2012

(54) FASTENING ASSEMBLY AND CLAMPING DEVICE AND ADAPTER FOR SAME

(76) Inventor: Marcus Scheinberger, Hofheim-Langenhain (DE)

(21) Appl. No.: 13/147,881

(22) PCT Filed: Feb. 5, 2010
(86) PCT No.: PCT/EP2010/000733

§ 371 Date: Oct. 13, 2011

(30) Foreign Application Priority Data
Feb. 6, 2009 (EP) 09001715.3

(51) Int. Cl. F16B 13/06; B25B 29/00; F16B 5/04; B21D 39/08

(52) U.S. Cl. 29/509; 411/38; 29/243.519; 173/165

(57) ABSTRACT

A fastening assembly for clamping plate-shaped components, including a clamping device used with a plastically deformable sleeve, and which has a housing, a nut element which is displaceably and rotatably accommodated therein, a feed rod engaged with the nut element, and a pressure sleeve which is displaceable relative to the feed rod in the axial direction thereof. An adapter may be used with the clamping device.

### CROSS-REFERENCE TO RELATED APPLICATIONS

This application is a §371 national phase application of and claims priority to International Patent Application No. PCT/EP2010/000733 filed Feb. 5, 2010, which in turn claims priority to European Patent Application No. 09001715.3, the disclosures of which are incorporated herein by reference in their entireties for all purposes.

### FIELD OF THE INVENTION

The invention relates to a fastening assembly for clamping plate-shaped components, having at least one plastically deformable disposable sleeve which has a defined weakened area for introducing a bulge-like deformation under a pressure load on such area, at least one clamping device which has a feed rod that is connectable to the disposable sleeve, and a pressure sleeve, movable relative to the feed rod, for supporting the disposable sleeve, and having actuating means for causing an axial relative motion between the pressure sleeve and the feed rod in a first actuating step of the fastening assembly, and for causing a joint axial motion of the pressure sleeve and the feed rod in a subsequent second actuating step of the fastening assembly. The invention further relates to a clamping device and an adapter for such a fastening assembly, and a method for clamping plate-shaped components using a clamping device and an adapter of the above-mentioned type.

### BACKGROUND OF THE INVENTION

A fastening assembly, as described above, is known from EP 1 889 688 A1. A mechanism is integrated into the clamping element of the fastening assembly described therein, the mechanism causing a pressure sleeve to be at least substantially stationarily held in the clamping device during a first phase of the displacement motion of the feed rod for deformation of the plastically deformable sleeve, and in the second phase of the displacement motion of the feed rod for clamping the components to be connected, causing the pressure sleeve together with the feed rod to move relative to a housing of the clamping device. This mechanism includes multiple spheres which are moved on appropriately designed guide surfaces in order to cause a relative motion between the pressure sleeve and the feed rod. In addition, a ratchet is provided in the clamping device which simplifies removal of the sleeve from the rest of the fastening assembly after use. The entire clamping device is designed in such a way that all tools necessary for the actuation directly engage with the housing or the nut element of the clamping device. As a result, the clamping device, which is sometimes installed in an inverted position, has a complex design and is also comparatively large and heavy.

Accordingly, the object of the present invention is to provide a fastening assembly of the type mentioned at the outset which is lighter and more compact, and therefore easier to handle.

### SUMMARY OF THE INVENTION

The foregoing object is achieved according to the invention essentially in that the actuating means are provided, at least in part, in a separate adapter which is detachably connectable to the clamping device. The invention is based on the concept of providing only the components in the clamping device which are directly required for clamping the components, while the components which perform the various motion sequences may be accommodated in a separate adapter part. The clamping device is thus much lighter and more compact. This also improves the ease of handling and further processing of the clamped components. The division of the different functions into separate components is also advantageous from an economic standpoint, since a single adapter may be used to process many clamping devices, and therefore it is not necessary to provide each clamping unit with its own actuating means.

Independently from this combination according to the invention of a clamping device and a separate adapter, the invention relates to a clamping device which is suited for use with a plastically deformable sleeve for clamping plate-shaped components. Such a clamping device has a housing which has an end-face contact surface for a component to be clamped, a nut element which is displaceably and rotatably accommodated in the housing and which has an internal thread section and engagement means for a first tool for introduction of a torque into the nut element, a feed rod which at one end has a first external thread section and at the opposite end has a second external thread section, one of the external thread sections being engaged with the internal thread section of the nut element, and a pressure sleeve which encloses the feed rod in sections and which is displaceable relative to the feed rod in the axial direction thereof. According to the invention, the feed rod of the clamping device is provided, at least in sections, with an opening in which means for transmitting and/or causing a displacement of the pressure sleeve relative to the feed rod in the axial direction thereof, and/or means for preventing rotation of the pressure sleeve relative to the feed rod, are provided. As a result of this displacement in the feed rod of the means which transmit and/or cause the relative motion between the pressure sleeve and the feed rod in the axial direction, and/or prevent rotation of these components, relative to one another, the entire clamping device is much lighter and more compact.

In a refinement of this inventive concept, it is provided that in the external thread section of the feed rod that is engaged with the internal thread section of the nut element, an axially extending opening is provided in which a pressure bolt is displaceably accommodated, and that at least one radially extending opening is provided in the feed rod which is connected to the axially extending opening and into which a pin is inserted which connects the pressure sleeve to the pressure bolt. In other words, the pressure bolt transmits a displacement motion applied by a separate component, together with the pin, to the pressure sleeve in such a way that the relative motion between the pressure sleeve and the feed rod is brought about. At the same time, the pin, which connects the pressure bolt accommodated in the feed rod to the pressure sleeve, prevents the pressure sleeve from twisting relative to the feed rod. These means for causing the relative displacement between the pressure sleeve and the feed rod, as well as the means for preventing the relative rotation between the pressure sleeve and the feed rod, particularly preferably have a symmetrical design; i.e. the pin extends in a direction perpendicular to the axial direction of the feed rod, through the entire thickness of the pressure sleeve and through the entire feed rod.

The pressure sleeve may be axially guided in the feed rod in a particularly simple manner by designing the radially extending opening in the feed rod as a slot whose length in the axial direction delimits the maximum displacement path of the pressure sleeve relative to the feed rod. At the same time, this slot prevents the relative rotation between the pressure sleeve and the feed rod. The length of the slot is dimensioned in such a way that at least one defined buckling of a sleeve which is connectable to the clamping device is caused in a first actuating step of the clamping device in such a way that a radial bulge is formed on the sleeve which engages behind a component to be clamped, and not until a second actuating step is the sleeve having the radial bulge, together with the pressure sleeve and the feed rod, moved relative to the other components of the clamping device in order to clamp the components.

Independently from the features described above, the underlying object of the invention for a clamping device of the type mentioned at the outset is also achieved in that that the pressure sleeve has a section situated between the nut element and the feed rod. This allows a particularly compact design of the clamping device, since the nut element, the pressure sleeve, and the feed rod are concentrically arranged, at least in sections. An arrangement of the pressure sleeve and nut element one behind the other, viewed in the axial direction of the feed rod, which results in a large overall length of the clamping device may thus be avoided.

According to one preferred embodiment, an elastic element, in particular a disk spring set, is accommodated in the housing, and acts on the nut element in a direction facing away from the end-face contact surface. This elastic element is thus situated in such a way that the nut element is pulled in the direction of the end-face contact surface, against the force of the elastic element in the housing, when the clamping device is actuated during the clamping of a component. If the component to be clamped undergoes settling, this may be compensated for by the elastic element without the clamping force falling below a specified value, for example. This is particularly advantageous when the clamping device according to the invention is used for adhesively bonding sandwich structures or other multilayer components, for which settling may be expected due to escape of a sealant or adhesive between the individual layers.

It is further preferred for the housing to have second engagement means for a second tool. This may be, for example, profiling at the end of the housing facing away from the end-face contact surface. In principle, however, it is also possible for the entire housing to have, for example, a polygonal contour for engagement with a second tool.

For actuating a clamping device of the aforementioned type, according to the invention an adapter is provided which is suitable for detachably connecting a driving tool for generating a torque using such a clamping device. Such an adapter according to the invention has first means for transmitting a torque as a first tool, second means for supporting a torque as a second tool, and a device for causing an axial relative motion between a sleeve and a pin accommodated therein. The adapter is particularly preferably adapted to a clamping device of the aforementioned type in such a way that the first means for transmitting a torque are able to cooperate with the nut element so that a driving tool conducts a torque into the nut element via the adapter. At the same time, the second means, which are preferably adapted to the housing of the clamping device, prevent twisting of the housing. This causes a relative motion between the nut element and the housing in a clamping device. In addition, a device is provided which is able to cause the relative motion between the feed rod and the pressure sleeve for forming a radial bulge in a plastically deformable sleeve which is connectable to the clamping device.

The adapter according to the invention thus contains several components or functional units, which in the device known from the prior art are integrated into the clamping device. The clamping device according to the present invention may thus be provided with a compact and light design. In addition, the clamping device is comparatively inexpensive to manufacture, since a portion of the functional units which are provided in the clamping device itself according to the prior art are integrated into the adapter, which is usable for a large number of clamping devices. Therefore, this division between a clamping device and an adapter also results in significant advantages from an economic standpoint. The first means and/or the second means of the adapter may each include an approximately sleeve-like element which has inner profiling for transmitting or supporting a torque. These first and second means in particular may be situated concentrically with respect to one another. It is thus possible for the adapter to be placed on the clamping device, and at the same time, for the first means to cooperate with the nut element and for the second means to cooperate with the housing.

The device for causing an axial relative motion between a sleeve and a pin accommodated therein preferably has a sleeve-like pressure adapter and a pressure bolt which is displaceably accommodated therein. A mechanism is associated with the pressure adapter and the pressure bolt, and is designed in such a way that it causes a relative motion between the pressure adapter and the pressure bolt when the pressure adapter moves axially along a displacement path segment. The relative motion which is transmittable to the feed rod and the pressure sleeve is thus generated in the adapter by means of the mechanism.

According to one particularly preferred embodiment of the invention, the mechanism includes at least one slide rail or slide surface, at least one sliding wedge which cooperates therewith, and at least one thrust wedge and/or support wedge which is/are associated with the pressure bolt and/or the pressure adapter. The pressure adapter may be designed as a sleeve in which the pressure bolt is displaceably accommodated. A thrust wedge associated with the pressure bolt as well as a support wedge connected to the pressure adapter are provided in one or more radial apertures, one or more sliding wedges being provided radially from the outside between the thrust wedge and the support wedge. When the pressure adapter is then moved in the axial direction inside the adapter, the at least one sliding wedge is pushed radially inwardly by a contour of the slide rail or slide surface, causing the thrust wedge and the support wedge to move apart from one another. This results in a relative motion of the pressure bolt in the pressure adapter. Alternatively, such a mechanism may be provided using spheres, for example as described in EP 1 889 688.

The device for causing an axial relative motion between a sleeve and a pin accommodated therein may have further means for supporting a torque. This allows the feed rod and/or the pressure sleeve to be held in a rotationally fixed manner in the housing of the clamping device, so that the rotational motion of the nut element results only in an axial motion relative to the nut element, not in rotation of the feed rod.

According to another preferred embodiment of the invention, gearing which is associated with the first means for transmitting a torque is provided in the adapter. Alternatively or additionally, connecting means may be provided for connection to the driving tool. The gearing allows the use of a conventional drive source, for example a pneumatically or electrically driven screwdriver, and at the same time allows adaptation to the ideal operating conditions for clamping components using the adapter or a clamping device.

The invention further relates to a method for clamping plate-shaped components between a clamping device and a plastically deformable sleeve, whereby the nut element, the housing, and/or the feed rod is/are detachably coupled to a driving tool by using an adapter, so that when the driving tool is actuated the nut element and the feed rod move relative to one another, as a result of which in a first step the plastically deformable sleeve is deformed while forming a radial bulge, and subsequently in a further step the radial bulge presses the plate-shaped components against the end-face contact surface of the housing of the clamping device.

### BRIEF DESCRIPTION OF THE DRAWINGS

The invention is explained in greater detail below based on one exemplary embodiment with reference to the drawings, which schematically show the following:

FIG. 1 shows a perspective view of a clamping device according to the invention;

FIG. 2 shows a longitudinal section of the clamping device according to FIG. 1;

FIG. 3 shows a perspective view of an adapter according to the invention;

FIG. 4 shows a longitudinal section of the adapter according to FIG. 3;

FIG. 5 shows a longitudinal section of the adapter according to FIG. 3, rotated by 90° with respect to FIG. 4;

FIGS. 6a-c show the adapter according to FIG. 3 in longitudinal sections corresponding to FIG. 4, in various positions;

FIG. 7 shows a longitudinal section of a plastically deformed sleeve; and

FIG. 8 shows a longitudinal section of the sleeve according to FIG. 7, before deformation.

### DETAILED DESCRIPTION OF THE DRAWINGS

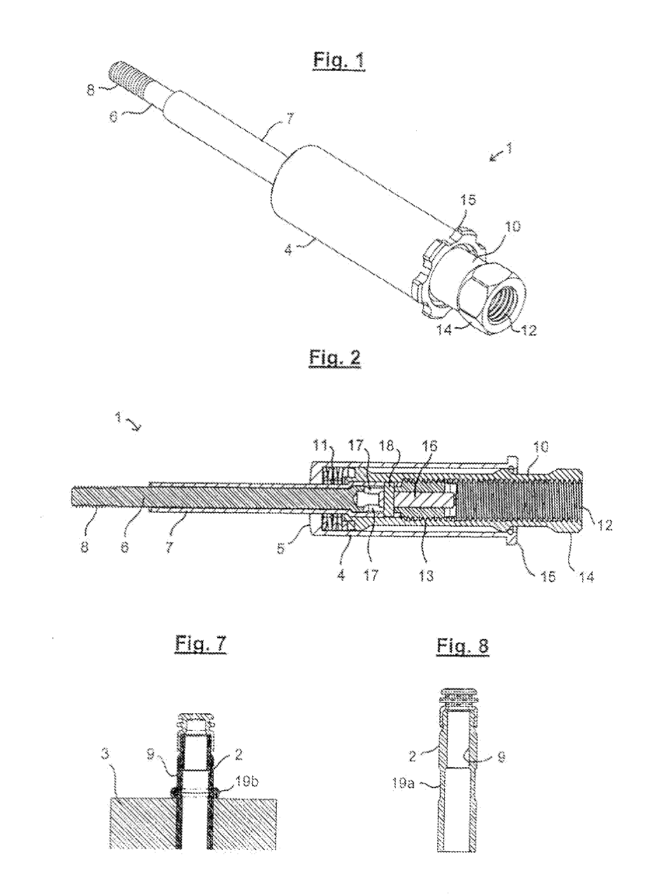

A clamping device 1 illustrated in FIGS. 1 and 2 is suitable for use with a plastically deformable sleeve 2, shown in FIGS. 7 and 8, for clamping at least one component 3 which is plate-like, for example. The clamping device 1 has an essentially cup-shaped housing 4 which has an end-face contact surface 5 with which the housing 4 may be placed against a component to be clamped. An opening is provided in the end-face contact surface 5 through which a feed rod 6, which is enclosed by a pressure sleeve 7 in places, projects from the housing 4. At its left end in FIG. 2 the feed rod 6 is provided with an external thread section 8, which for connection of the clamping device 1 to the plastically deformable sleeve 2 may be brought into engagement with a corresponding internal thread section 9 in the sleeve 2. The outer diameter of the plastically deformable sleeve 2 corresponds, in sections, to the outer diameter of the pressure sleeve 7, so that the feed rod together with the plastically deformable sleeve 2 and the pressure sleeve 7 may be passed through an opening in the component 3 to be clamped.

Also provided in the housing 4 of the clamping device 1 is a nut element 10 which may be displaced within the housing 4 in the axial direction of the feed rod 6 and twisted relative to the housing 4. A disk spring set 11 is provided between the end-face contact 5 of the housing 4 and the left end face of the nut element 10 in FIG. 2 in such a way that the nut element 10 is pushed to the right in FIG. 2. A disk and a thrust washer may be situated between the disk spring set 11 and the nut element 10. The nut element 10 has a hollow design, and in its right section in FIG. 2 has an internal thread 12 which engages with an external thread section 13 of the feed rod 6. The nut element 10 thus concentrically encloses the pressure sleeve 7 and the feed rod 6 in places. In the exemplary embodiment illustrated, the nut element 10 is secured against falling from the housing by a snap ring at the right end of the housing 4 in FIG. 2.

As is apparent from FIG. 1, at its end projecting from the housing 4 the nut element 10 has a hexagon head which forms a first engagement means 14 for introducing a torque into the nut element. Also provided at the right end of the housing 4 in FIG. 2 is profiling which forms a second engagement means 15 for supporting a torque.

The section of the feed rod 6 accommodated in the nut element 10 in FIG. 2 has an essentially hollow design, a pressure bolt 16 which extends in the axial direction of the feed rod 6 being inserted into the borehole, which in the illustrated embodiment is cylindrical. This pressure bolt extends to a region of the feed rod 6 in which two radial slots 17, extending over a defined distance in the axial direction of the feed rod 6, are provided. As shown in FIG. 2, the pressure bolt 16 is provided with a transverse bore into which a cylindrical pin 18 is inserted. The cylindrical pin 18 projects through the window-like slots 17 to the outside beyond the feed rod 6, and engages in openings in the pressure sleeve 7. In this manner the cylindrical pin 18 connects the pressure bolt 16 to the pressure sleeve 7 in such a way that an axial displacement motion of the pressure bolt 16 inside the feed rod 6 causes a relative displacement motion between the pressure sleeve 7 and the feed rod 6. At the same time, the slots 17 in the feed rod 6 are dimensioned in such a way that the cylindrical pin 18 prevents the pressure sleeve 7 from twisting relative to the feed rod 6.

In its undeformed state shown in FIG. 8, an end face of the sleeve 2 initially rests against the left end face of the pressure sleeve 7 in FIG. 2. The sleeve 2 is provided with a weakened area 19a which simplifies a defined buckling of the sleeve 2 when pressure is exerted on the sleeve between this end face and the internal thread section 9. As described in greater detail below with reference to FIGS. 3 through 6, the feed rod 6 may be supported to prevent co-rotation when the nut element 10 is turned, causing the feed rod 6 to be moved in the nut element 10 to the right in FIG. 2. A mechanism which is likewise described below may cause the actuation in a first step in such a way that during this motion of the feed rod 6 in the nut element 10, the pressure bolt 16 and therefore the pressure sleeve 7 is initially not also moved to the right in FIG. 2, but instead remains essentially stationary. This causes the feed rod 6 to be retracted into the pressure sleeve 7. As a result of the displacement of the feed rod 6 relative to the pressure sleeve 7, the plastically deformable sleeve 2 is initially deformed in such a way that a radial bulge 19b is formed in the weakened area 19a. The sleeve 2, the pressure sleeve 7, and the feed rod 6 together may be subsequently moved to the right in FIG. 2, causing the radial bulge 19b to rest against the component 3 to be clamped.

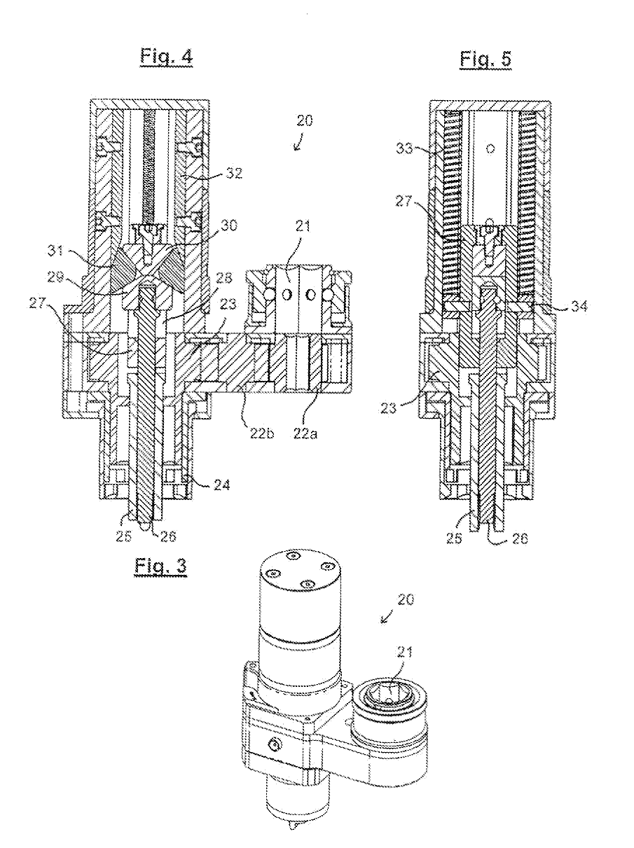

FIGS. 3 through 6 illustrate an adapter 20 which may be used for transmitting a torque between a driving tool (not shown) and the previously described clamping device 1. For this purpose the adapter 20 has a connection opening 21 for connecting the driving tool. Via two intermeshing gear wheels 22a, 22b the torque of the driving tool is transmitted to a sleeve-like drive shaft 23, which is provided with external toothing which meshes with the gearwheel 22b. The lower end of the drive shaft 23 in FIG. 4 is designed in such a way that it is able to enclose the first engagement means 14 of the clamping device so that a torque may be transmitted to the nut element 10. The drive shaft 23 is concentrically enclosed by a housing region 24 of the adapter 20 which is provided at the housing 4 of the clamping device for connection to the second engagement means 15. The housing 4 of the clamping device is therefore held on the adapter 20 in a rotationally fixed manner.

A sleeve-like pressure adapter 25 and a pressure bolt 26 which is displaceably guided therein are concentrically situated in the drive shaft 23. The pressure bolt 26 is adapted to the size of the pressure bolt 16 of the clamping device in such a way that the pressure bolt 16 is displaceable by means of the pressure bolt 26. At the same time, the pressure adapter 25 is adapted to the right end of the feed rod 6 in FIG. 2 in order to support same. In addition, torque transmission means which are engageable with one another may be provided between the right end of the feed rod 6 in FIG. 2 and the end-face lower end of the pressure adapter 25 in FIG. 4, on account of the rotationally fixed bearing of the pressure adapter 25 in the adapter 20, the torque transmission means prevent twisting of the rod 6 when the nut element 10 is actuated.

The pressure adapter 25 is accommodated in the adapter 20 so that the pressure adapter is displaceable in its axial direction. In an extension of the pressure adapter 25, a carriage 27 which likewise concentrically encloses the pressure bolt 26 is provided in the adapter 20. Two radial apertures 28 are provided in the carriage 27 which allow a thrust wedge 29, connected to the pressure bolt 26, to extend out of the carriage 27 in places. A support wedge 30 is provided in the carriage 27, opposite from the thrust wedge 29, in such a way that two radial concave free spaces result between the thrust wedge 29 and the support wedge 30 when these rest against one another (FIGS. 4, 5, and 6a). The adapter 20 also has two sliding wedges 31 which are inserted into these free spaces from the outside. An inner contour is formed in the adapter 20 by slide rails 32, and initially forms an enlarged cross section, and in a region thereabove in FIG. 4 forms a tapered cross section.

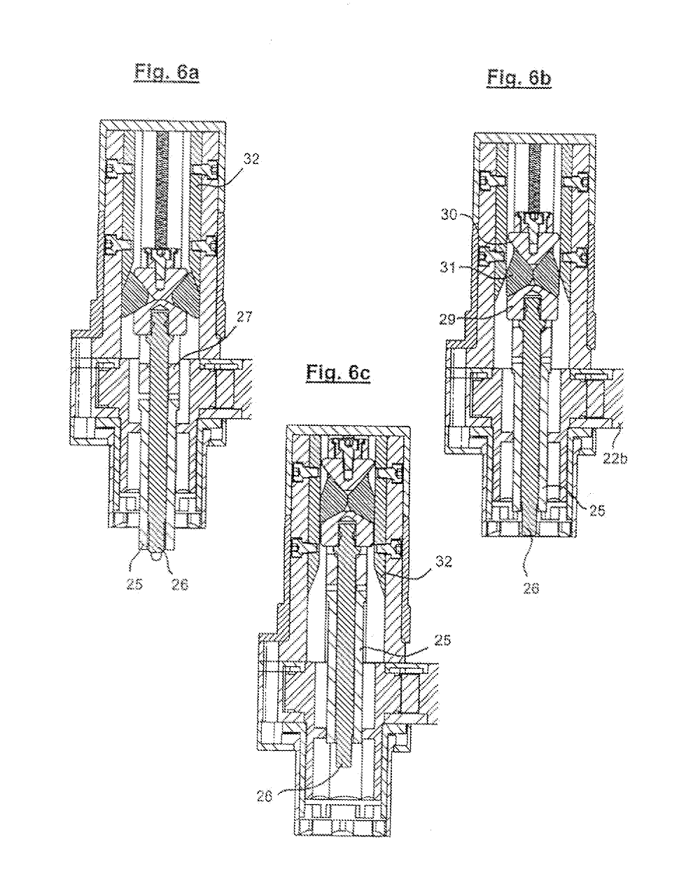

As a result, when the pressure adapter 25 is displaced upwardly from the position shown in FIGS. 4 through 6a by the actuation of the nut element 10, and therefore the feed rod 6 is displaced, the pressure adapter 25 initially abuts against the carriage 27, and then together with same is displaced upwardly in FIG. 4. As shown in FIG. 6b, this causes the sliding wedges 31 to be pushed into the free space between the thrust wedge 29 and the support wedge 30, resulting in a relative motion between the pressure bolt 26 and the pressure adapter 25. In other words, the pressure bolt 26 is advanced from the sleeve-like pressure adapter 25 when the pressure adapter 25 is moved upwardly in FIG. 6a. This allows the pressure sleeve 7 to move relative to the feed rod 6 in order to form the radial bulge 19b in the plastically deformable sleeve 2.

As a result of the motion sequence illustrated in FIGS. 6a through 6c, the deformation process of the weakened area 19a of the sleeve 2 to form the bulge 19b may occur with a comparatively low drive torque. This ensures that in the position of the adapter 20 shown in FIG. 6b the bulge 19b is completely formed, and thus does not occur until the component 3 is actually clamped, when the adapter is moved further into the position shown in FIG. 6c.

Via springs 33 shown in FIG. 5, the carriage 27 is pushed downward as shown in FIG. 4, i.e., into its starting position, in which the thrust wedge 29 rests against the support wedge 30. Cylindrical pins 34 transmit the elastic forces to the carriage 27. The torque which is transmitted via the pressure adapter 25 is absorbed as a result of the carriage geometry, and also by means of wedges 29, 30, and 31.

List of reference numerals

| | |
|---|---|
| 1 | Clamping device |
| 2 | Sleeve |
| 3 | Component to be clamped |
| 4 | Housing |
| 5 | Contact surface |
| 6 | Feed rod |
| 7 | Pressure sleeve |
| 8 | External thread section |
| 9 | Internal thread section |
| 10 | Nut element |
| 11 | Disk spring set |
| 12 | Internal thread |
| 13 | External thread |
| 14 | First engagement means |
| 15 | Second engagement means |
| 16 | Pressure bolt |
| 17 | Slot |
| 18 | Cylindrical pin |
| 19a | Weakened area |
| 19b | Bulge |
| 20 | Adapter |
| 21 | Connection opening |
| 22a, b | Gearwheel |
| 23 | Drive shaft |
| 24 | Housing section |
| 25 | Pressure adapter |
| 26 | Pressure bolt |
| 27 | Carriage |
| 28 | Aperture |
| 29 | Thrust wedge |
| 30 | Support wedge |
| 31 | Sliding wedge |
| 32 | Slide rail |
| 33 | Spring |
| 34 | Pin |

What is claimed is:

1. A fastening assembly for clamping plate-shaped components, comprising at least one plastically deformable disposable sleeve having a defined weakened area for introducing a bulge-like deformation under a pressure load applied on the weakened area, at least one clamping device having a feed rod that is connectable to the disposable sleeve, and a pressure sleeve, movable relative to the feed rod, for supporting the disposable sleeve, and having actuating means for causing an axial relative motion between the pressure sleeve and the feed rod in a first actuating step of the fastening assembly, and for causing a joint axial motion of the pressure sleeve and the feed rod in a subsequent second actuating step of the fastening assembly, the actuating means provided, at least in part, in a separate adapter which is detachably connectable to the at least one clamping device.

2. A clamping device for use in a fastening assembly for clamping plate-shaped components, comprising a housing which includes an end-face contact surface for one of the components to be clamped, a nut element which is displaceably and rotatably accommodated in the housing and which has an internal thread section and first engagement means for engaging a first tool for introduction of a torque into the nut element, a feed rod which at one end has a first external thread section and at an opposite end has a second external thread section, one of the first and second external thread sections being engaged with the internal thread section of the nut element, and a pressure sleeve enclosing the feed rod in sections and which is displaceable relative to the feed rod in the axial direction thereof, the feed rod being provided, at least in sections, with an opening in which means for transmitting and causing a displacement of the pressure sleeve relative to the feed rod in the axial direction thereof, and means for preventing rotation of the pressure sleeve relative to the feed rod, are provided.

3. The clamping device of claim 2, wherein in the first or second external thread section of the feed rod that is engaged with the internal thread section of the nut element, an axially extending opening is provided in which a pressure bolt is displaceably accommodated, and at least one radially extending opening is provided in the feed rod which is connected to the axially extending opening and into which a pin is inserted which connects the pressure sleeve to the pressure bolt.

4. The clamping device of claim 3, wherein the at least one radially extending opening is a slot whose length in the axial direction delimits the maximum axial displacement path of the pressure sleeve relative to the feed rod.

5. The clamping device of claim 2, wherein the pressure sleeve has a section situated between the nut element and the feed rod.

6. The clamping device of claim 2, further comprising an elastic element that is accommodated in the housing, and acts on the nut element in a direction facing away from the end-face contact surface of the housing.

7. The clamping device of claim 2, wherein the housing includes second engagement means for engaging a second tool.

8. An adapter for use in a fastening assembly for detachably connecting a driving tool for generating a torque using a clamping device, the adapter comprising first means for transmitting a torque as a first tool, second means for supporting a torque as a second tool, and a device for causing an axial relative motion between a sleeve and a pin accommodated therein.

9. The adapter of claim 8, wherein each of the first means and the second means includes a sleeve-like element having inner profiling for transmitting and supporting a torque.

10. The adapter of claim 8, wherein the first and second means are situated concentrically with respect to one another.

11. The adapter of claim 8, wherein the device for causing an axial relative motion between the sleeve and the pin accommodated therein includes a sleeve-like pressure adapter and a pressure bolt which is displaceably accommodated therein, and wherein a mechanism is associated with the pressure adapter and the pressure bolt, the mechanism being adapted to cause a relative motion between the pressure adapter and the pressure bolt when the pressure adapter moves axially at least along a defined displacement path segment.

12. The adapter of claim 11, wherein the mechanism includes at least one slide rail, at least one sliding wedge which cooperates with the at least one slide rail, and at least one thrust wedge and at least one support wedge which are associated with the pressure bolt and the pressure adapter.

13. The adapter of claim 8, wherein the device for causing an axial relative motion between the sleeve and the pin accommodated therein includes further means for supporting a torque.

14. The adapter of claim 8, wherein the first means includes gearing for transmitting a torque and connecting means for connection to the driving tool.

15. A method for clamping plate-shaped components, comprising the steps of:
providing at least one plastically deformable sleeve;
providing a clamping device that includes a housing, a feed rod and a nut element that are detachably coupled to a driving tool by an adapter; and
actuating the driving tool such that the nut element and the feed rod move relative to one another, as a result of which the plastically deformable sleeve is deformed while forming a radial bulge, and subsequently the radial bulge presses the plate-shaped components against an end-face contact surface of the housing of the clamping device.
